(19) United States
(12) Patent Application Publication
(10) Pub. No.: US 2015/0264763 A1
(43) Pub. Date: Sep. 17, 2015

(54) INTEGRATING INTO A CAPACITOR DEVICE AN INDICATOR OF THE CAPACITOR OPERATING OUTSIDE OF SPECIFICATION

(71) Applicant: INTERNATIONAL BUSINESS MACHINES CORPORATION, ARMONK, NY (US)

(72) Inventors: Milton Cobo, Raleigh, NC (US); Michael DeCesaris, Carrboro, NC (US); Luke D. Remis, Raleigh, NC (US); Gregory D. Sellman, Morrisville, NC (US)

(73) Assignee: INTERNATIONAL BUSINESS MACHINES CORPORATION, ARMONK, NY (US)

(21) Appl. No.: 14/203,806

(22) Filed: Mar. 11, 2014

(51) Int. Cl. H05B 33/08; H05B 33/10

(52) U.S. Cl. CPC H05B 33/0821; H05B 33/10

(57) ABSTRACT

In an approach to design and build a capacitor with an integrated indicator of operation above a specified voltage rating, a light emitting device is calibrated to illuminate in response to a level of electrical stimulation and a resistor connected to the light emitting device wherein, the resistance of the resistor is determined at least in part by to the calibration of the light emitting device. The capacitor core with a specified voltage rating for operation has at least a first capacitor lead and a second capacitor lead wherein the first capacitor lead connects to the resistor and the second capacitor lead connects to the light emitting device. A protective coat covers each of the connections between the light emitting device, the resistor, and the capacitor core, such that the light emitting device is visible.

### FIELD OF THE INVENTION

The present invention relates generally to the field of capacitor devices, and more specifically, to integrating into a capacitor device an indicator of the capacitor operating outside of specification.

### BACKGROUND

A capacitor is a passive electrical component used to store energy electrostatically in an electrical field. Capacitors are used for many purposes in electronic circuits, analog filter networks, and electronic power transmission systems, including smoothing out spikes or drops in voltage and releasing sudden bursts of power in applications such as a camera flash. Capacitors contain at least two electrical conductors or plates separated by a dielectric or insulating material and, in most cases, with two leads or terminals for connection to an electrical circuit. A common construction of a capacitor consists of metal foils separated by a thin layer of an insulting film. When voltage passes through a capacitor, it creates an electric field in the dielectric where a positive charge collects on one plate and a negative charge collects on the other plate, thus storing energy in the electric field. The dielectric or insulator between the plates passes a small amount of leakage current and has an electric field strength limit, also known as a breakdown voltage, inherent to the dielectric within the capacitor.

Common types of capacitors include ceramic capacitors, film capacitors, electrolytic capacitors, and super capacitors. Within these general groups of capacitors several different types of capacitors may exist, for example, ceramic capacitors may include simple single layer disc ceramic disk capacitors or more complex multilayer ceramic capacitors (MLCC). Electrolytic capacitors include aluminum, tantalum, or paper/film electrolytic capacitors. While the technology creating layers of conductors separated by a thin insulating dielectric is different, some similarities exist in many of the finished capacitor constructions. In general, capacitors are two leaded where connections to the electrical circuit may be made with leads, pin-in-hole (PIH), or surface mount (SMT), although some specially constructed capacitors may be used for high voltage applications (pulsed lasers, particle accelerators or capacitor banks in power transmission systems).

### SUMMARY

The present invention provides methods and structures for a capacitor with an integrated indicator of operation above a specified voltage rating. The method and structure include a light emitting device calibrated to illuminate in response to a level of electrical stimulation and a resistor connected to the light emitting device wherein, a resistance of the resistor is determined at least in part by the calibration of the light emitting device. The capacitor core with a specified voltage rating for operation with at least a first capacitor lead and a second capacitor lead wherein the first capacitor lead connects to the resistor and the second capacitor lead connects to the light emitting device. A protective coat covers each of the connections between the light emitting device, the resistor, and the capacitor core, such that the light emitting device is visible.

### BRIEF DESCRIPTION OF THE SEVERAL VIEWS OF THE DRAWINGS

The following detailed description will best be understood in conjunction with the accompanying drawings. It should be understood that these drawings are not to scale and various features may be increased or reduced for discussion of particular components.

FIG. 1 is a cross-sectional view of a capacitor with an integrated indicator, in accordance with an embodiment of the present invention.

FIG. 2 depicts a circuit diagram of a capacitor with an integrated indicator, in accordance with an embodiment of the present invention.

FIG. 3 is a flow chart illustrating the steps of a method to assemble the capacitor with an integrated indicator of FIG. 1, in accordance with an embodiment of the present invention.

### DETAILED DESCRIPTION

Embodiments of the present invention generally provide a capacitor with an integrated indicator of operation over a specified capacitor voltage rating. Detailed embodiments of the claimed structures and methods are disclosed herein; however, it is to be understood that the disclosed embodiments are merely illustrative of the claimed structures and methods that may be embodied in various forms. Descriptions of well-known components and processing techniques may be omitted so as to not unnecessarily obscure the embodiments herein. In addition, specific structural and functional details disclosed herein are not to be interpreted as limiting, but merely as a representative basis for teaching one skilled in the art to variously employ the methods and structures of the present disclosure.

Embodiments of the present invention recognize that the efficient operation of a capacitor above a specific electric field is limited since the dielectric in the capacitor becomes conductive. The voltage at which the electric field exceeds the dielectric strength (E_{ds}) is known as the breakdown voltage of the capacitor. The breakdown voltage is determined by the dielectric strength of the dielectric material and the space or distance between the conductors or conductive plates.

Capacitors are a common component in printed circuit board (PCB) design and assembly. An occasionally overlooked element of PCB design is the selection of a capacitor with an appropriate voltage rating for the PCB design, potentially resulting in a selected capacitor operating over the rated voltage. A more common occurrence for using a capacitor with an inappropriate voltage rating may occur in manufacturing where a large number of different types of capacitors are available for assembly. In some cases, the wrong capacitor may be inadvertently selected for a PCB and, consequently, the capacitor may have the incorrect voltage rating for the specific assembly or application. The occurrence of either of these events may not be easily detected until failure. A capacitor operating over the specified voltage or breakdown voltage may function during electrical test at the assembled board level and even through system test. In some cases, a system may be shipped with capacitors operating outside of their voltage specification and failure of the system may occur, such as with a power plane short to ground, disabling the system. A system fail in the field is costly to repair, and can be catastrophic to a customer and the customer relationship. Embodiments of the present invention recognize that a capacitor's voltage rating is not generally indicated on the capacitor itself, and identifying an assembly with an incorrect capacitor during manufacturing and in the field may be challenging, especially as many PCB designs use numerous capacitors and more than one type (multiple part numbers), often with similar sizes and construction.

Embodiments of the present invention propose a structure and a method to provide a capacitor with an integrated indicator for operation outside of the capacitor's specified capabilities and, in particular, for indicating a capacitor operating above the specified voltage rating. Embodiments of the present invention utilize a light emitting diode (LED) and resistor integrated into the capacitor creating a single integrated component. The LED and resistor integrated into the capacitor are customized or “tuned” to the specific voltage rating for the capacitor. The LED and resistor are connected in series with each other and are connected in parallel to the capacitor core in a single, integrated component. The LED is calibrated or tuned to the capacitor's specified voltage rating and is calibrated so that when a threshold voltage is detected, the LED activates or lights up. The threshold voltage corresponds to a value over the specified capacitor voltage rating. A lit up capacitor structure may be easily detected at card assembly test, board level test, system test or in the field. A capacitor with an integrated indicator which may be an LED can light up to indicate operation over the specified capacitor rating. While embodiments of the present invention discuss PCB applications, use of the various embodiments of the present invention is not limited to PCB applications but, may be included in other types of applications.

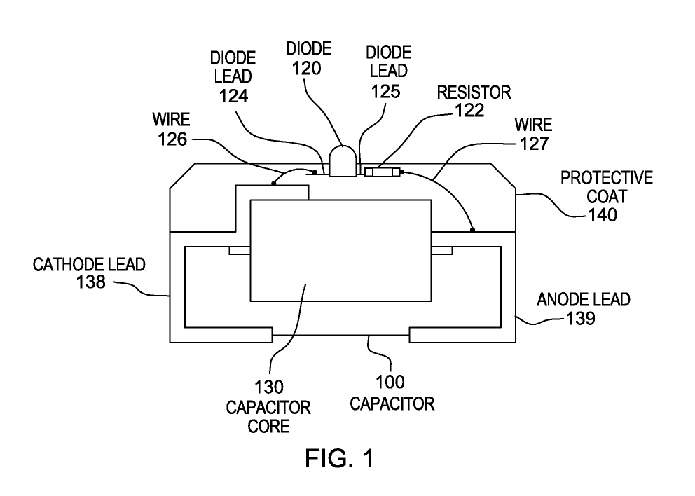

The present invention will now be described in detail with reference to the Figures. FIG. 1 is a cross-sectional view of a capacitor with an integrated indicator, in accordance with an embodiment of the present invention. In the exemplary embodiment, capacitor 100 is a tantalum capacitor. While the exemplary embodiment of the present invention depicted in FIG. 1 is shown as a tantalum capacitor, this embodiment is not meant to restrict other embodiments to tantalum capacitors but, may encompass aluminum capacitors, ceramic capacitors, paper or plastic electrolytic capacitors, super capacitors, double layer and other capacitor types in other embodiments of the present invention.

Capacitor 100 includes diode 120, resistor 122, attachment wires 126 and 127 along with capacitor core 130, cathode lead 138, anode lead 139, and protective coat 140. Capacitor core 130, cathode lead 138, and anode lead 139 may be assembled using industry standard practices as familiar to one skilled in the art.

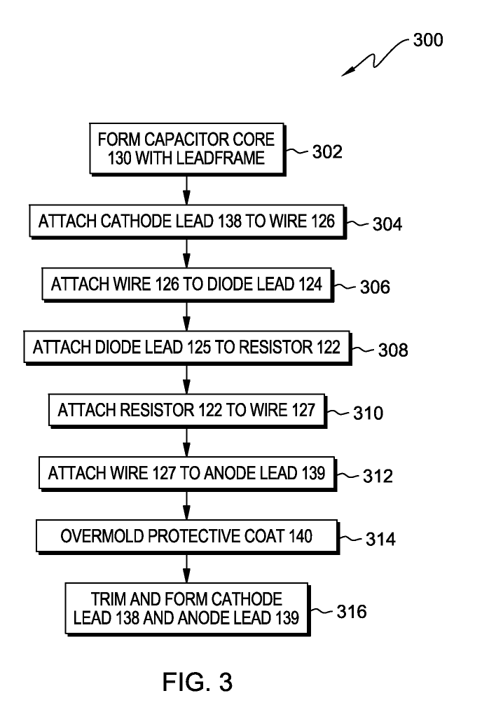

In the exemplary embodiment, capacitor core 130 is a tantalum capacitor core for a tantalum capacitor. A tantalum capacitor consists of a slug of sintered tantalum pellets with an embedded wire and coatings as discussed later with reference to FIG. 3. Capacitor core 130 includes a wire, a sintered/anodized slug with a conductive plastic which may be inside and around the sintered/anodized slug and the capacitor leads, shown as cathode lead 138 and anode lead 139 in FIG. 1. Capacitor core 130 may have a specified voltage rating for operation based at least in part on the capacitor core construction and electrical properties such as breakdown voltage. In the following discussions of the capacitor voltage rating or capacitor maximum voltage rating, the capacitor core, or capacitor core 130, drives or determines capacitor voltage rating as evaluated by the capacitor manufacturer. For the purposes of embodiments of the present invention, the capacitor voltage rating is the capacitor core (capacitor core 130) voltage rating. In other embodiments of the present invention, capacitor core 130 may be another capacitor type, for example, a multilayer ceramic capacitor (MLCC) where the core consists of layers of metalized ceramic constructed using industry practices familiar to one skilled in the art.

Diode 120 can be a light emitting diode (LED) or another electrically stimulated light emitting device that is customized with a resistor, for example, resistor 122 in FIG. 1, for the specific capacitor and circuit design of capacitor 100. In an embodiment, diode 120 may be a LED which is made of a semiconductor material doped with impurities to create a p/n junction. When a LED voltage known in the art as the LED forward threshold voltage is exceeded, electrons flow from the anode (p side) to the cathode (n side) of the p/n junction and as the electrons meet with a hole in the semiconductor material, energy is released in the form of photons with a specific wavelength, as determined by the semiconductor material. Diode 120 may be customized as determined by a designer such that the LED's forward threshold voltage may be calibrated above the capacitor's maximum voltage rating according to a designer determined safety factor. The LED with a forward threshold voltage that is greater than the capacitor's specified voltage rating may illuminate when the capacitor is operating over the specified maximum voltage rating.

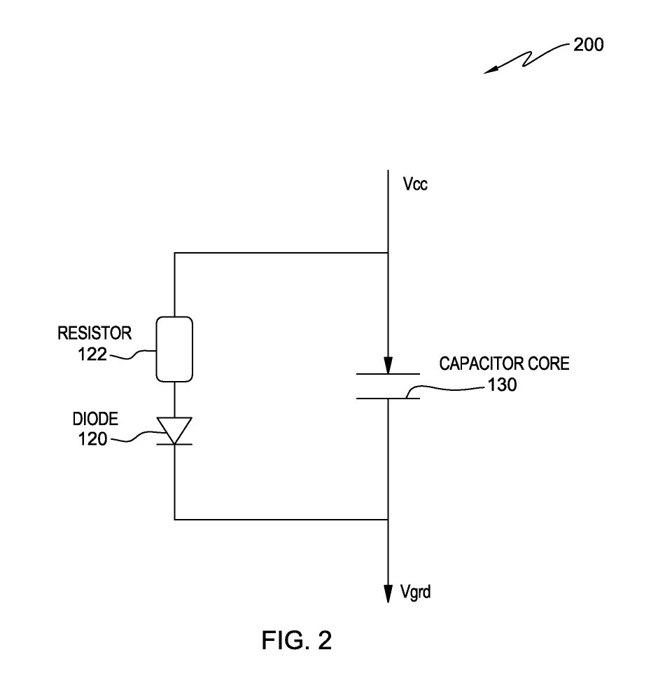

In some embodiments, when the capacitor's specified maximum voltage rating is high, for example, greater than several hundred volts, a LED may be constructed with one or more additional p/n junctions, as used in standard or zener diodes, added to the semiconductor substrate in series with the LED p/n junction emitting photons. When a capacitor with a high maximum voltage is used, the additional standard p/n junctions in series on the semiconductor substrate with the light emitting LED p/n junction may aide matching or providing a closer match between the capacitor specified maximum voltage and the LED threshold voltage. In the exemplary embodiment, diode 120 is customized and manufactured to a designer's specifications along with a resistor and integrated into the capacitor's body, typically at a manufacturing site. However, in some embodiments, diode 120 may be a commercially available LED which may have an integrated resistor or may use a separate component for the resistor. The LED component and/or resistor component may be assembled with capacitor core 130 as discussed below in FIG. 2.

Diode 120 may be used as an indicator of a capacitor which is operating over the specified voltage. Operation of LED's with the use of resistors is known to one skilled in the art. Diode 120 is calibrated through known manufacturing methods to activate when the forward voltage exceeds a specified threshold voltage of the LED thus activating the LED. The activated LED diode, diode 120, illuminates and may be easily viewed and identified as a capacitor operating in a voltage condition over threshold voltage.

The threshold voltage activating the LED may be determined by using conventional circuit design principals considering the capacitor's specified maximum voltage with a designer determined safety factor. For example, a LED threshold voltage may be determined as follows:

LED_{threshold}=(capacitor maximum voltage+safety factor)

where the safety factor may be for example, ten percent of the capacitor's maximum voltage as determined by the designer based on the application and the requirements of the application. The designer may determine an appropriate value for the safety factor based at least in part on the desired capacitor voltage rating (how large is the maximum specified voltage) and balancing the need to provide a reliable indication of a capacitor that may be in a harmful environment, operating over the specified maximum voltage, and reducing the chances of a false positive which would inaccurately indicate a capacitor operating above the specified voltage rating. When the LED voltage exceeds the LED_{threshold} voltage, thus, indicating that the incoming voltage to the capacitor is over the capacitor's specified maximum voltage, the LED lights up. Diode 120 may be tuned or customized to the desired LED_{threshold} as determined by the capacitor's voltage rating and the designer. Diode 120 and resistor 122 may be tuned or customized in conjunction to meet the design specified electrical requirements for the application.

Diode 120 is connected to each of diode lead 124 and diode lead 125, which are connected to wire 126 and resistor 122 respectively. In the exemplary embodiment, diode 120 resides on top of capacitor core 130 as shown in FIG. 1, however in other embodiments; diode 120 may be located in other positions adjacent to capacitor core 130. In the exemplary embodiment, diode 120 is embedded in protective coat 140 with an LED dome extending above and out of protective coating 140 so that activation of the LED diode is visible to an observer. The activated LED is visible to an observer indicating capacitor 100 is operating over the specified voltage rating.

In the exemplary embodiment, resistor 122 is a current limiting resistor. Resistor 122 is connected to diode 120 via diode lead 125 and limits the amount of current flowing to diode 120, and is connected to anode lead 139 via wire 127. Resistor 122 may be a resistive wire or element directly attached to the LED semiconductor at a foundry or another manufacturing site. In some embodiments, resistor 122 may be a commercially available component. As known in the art, once a LED receives the LED forward voltage or LED_{threshold}, the current has an exponential relationship with voltage above the characteristic forward voltage such that a small increase in the voltage results in a large current which may burn out the LED. In order to prevent inadvertent damage to the LED, a current limiting resistor may be used in series with the LED. The current limiting resistor used in series with the LED keeps the current flowing to the LED at the level specified for LED operation thus, preventing LED burn out. In some embodiments, a LED may be purchased or manufactured with an integrated resistor, providing a single LED/resistor element or component. The selection of resistor 122 may be determined by the designer utilizing the specified LED component requirements and the capacitor voltage rating. The LED's forward voltage and forward current specifications may be used in conjunction with the capacitor voltage rating for maximum capacitor voltage and the designer's selection of appropriate safety factors or tradeoffs. The LED forward threshold voltage or LED_{threshold} as shown above is equal to the capacitor maximum voltage rating and a designer determined safety factor. An example of an equation that may be used to calculate the appropriate resistance for determining resistor 122 is as follows:

R=[(desired voltage for over voltage indication_−LED_{threshold})/LED forward current]
where desired voltage for over voltage indication is equal to LED_{threshold} and the voltage drop across the resistor and the LEDforward current is the specified LED forward current.
   The designer may balance the desire to protect the LED where better protection results in a larger voltage drop across the resistor and an accurate indicator of a capacitor operating above the maximum capacitor voltage rating. The designer may determine the desired resistance value for resistor 122 based on an application in which the resistor will be used for example, a high reliability, high cost application or a low cost application. In some cases, a commercial resistor may be selected which is rated close to or just above R, where R is the resistance determined for the LED. Resistor 122 may be customized for diode 120 and Fto capacitor core 130 for capacitor 100.

Wire 126 creates electrical connections between diode lead 124 and cathode lead 138 connected to capacitor core 130. Wire 127 creates electrical connections between resistor 122 and anode lead 139 connected to capacitor core 130. Wires 126 and 127 may be a wire, a metal ribbon, metal tape, tabs or other connective form. In the exemplary embodiment, wires 126 and 127 are attached by welding however, in other embodiments, wires 126 and 127 may use one or more of welding, wire bonding, conductive adhesives, soldering, or other joining technology to create electrical connections and attachments between the leads and components (capacitor core 130, diode 120 and resistor 122). In another embodiment, diode lead 124 may be directly attached to cathode lead 138 by welding for example thus, eliminating wire 126. Similarly, resistor 122 may be directly attached to anode lead 139, for example by welding or another attachment method. In addition, a combination of these alternative attachments, such as through direct welding diode lead 124 to cathode lead 138 and wire bonding anode lead 139 to resistor 122, for example, may be used in the manufacture of capacitor 100. In other some embodiments, wire 126 may be attached simultaneously to the diode lead 124 and cathode lead 138 as may be wire 127 with attachments to anode lead 139 and resistor 122.

Protective coat 140 may be applied to cover the wires and connections between diode 120, resistor 122, and capacitor core 130. In the exemplary embodiment, protective coat 140 is a plastic overmold that completes assembly of capacitor 100. In the exemplary embodiment, protective coat 140 does not cover the dome of the LED in diode 120, leaving diode 120 visible to an observer. In some embodiments, protective coat 140 may be an epoxy, glob top, or other material applied to the electrical connections made by wire 126 and wire 127 to the respective leads on capacitor core 130 (cathode lead 138 and anode lead 139), resistor 122 leads and diode 120 leads 124 and 125 to protect the connections from handling or environmental damage yet leaves the LED dome visible. In another embodiment, protective coat 140 may be colorless, transparent clear coat and can extend over the LED dome thus, leaving it visible to an observer.

FIG. 2 depicts a circuit diagram 200 of capacitor 100 with an integrated indicator, in accordance with an embodiment of the present invention. Current flows into capacitor core 130 from a power source (V_{cc}) through the capacitor anode lead, for example, anode lead 139 of FIG. 1, to resistor 122 and through to diode 120. Resistor 122 and diode 120 are connected in series with each other. Resistor 122 and diode 120 are connected in parallel to capacitor core 130. Current flows out of capacitor 100 to ground (V_{grd}).

FIG. 3 is a flow chart 300 illustrating the steps of a method to assemble the capacitor 100 with an integrated indicator, in accordance with an embodiment of the present invention. Diode 120 and resistor 122 may be customized to the electrical requirements specified by a designer for a specific application utilizing capacitor 100 prior to assembling capacitor 100.

In step 302, form capacitor core 130 with leadframe as known to one familiar with that art which may be a stamped or similarly formed metal strip or carrier as used in the manufacture and assembly of components, particularly surface mount components or devices. In the illustrative embodiment, capacitor core 130 is a tantalum capacitor core manufactured with standard industry practices as known to one skilled in the art. In the exemplary embodiment, capacitor core 130 includes a tantalum wire in a slug of sintered tantalum pellets anodized to create a thin dielectric coating for example, tantalum pentoxide, on the sintered tantalum. The wire with the slug of sintered and anodized tantalum pellets may be layered with a conductive polymer and coated with carbon and a silver paint. A metal leadframe may be attached by silver adhesive to the surface layer of conductive polymer on the tantalum slug to complete capacitor core 130. In other embodiments, a pin-in-hole (PIH) capacitor core may be produced using wires or wire leads instead of a leadframe for surface mount (SMT) technology card assembly.

In step 304, attach cathode lead 138 to wire 126. In an embodiment, cathode lead 138 is welded to wire 126. Wire bonding, soldering, and conductive adhesives, for example, may also be used to attach wire 126 to cathode lead 138.

In step 306, attach wire 126 to diode lead 124. In an embodiment, wire 126 is welded to diode lead 124 however, attachment may also be done using, for example, wire bonding, soldering and conductive adhesives. In other embodiments, diode lead 124 may be directly attached or welded to cathode lead 138.

In step 308, attach diode lead 125 to resistor 122. In an embodiment, diode lead 125 is welded to resistor 122, however, in other embodiments, additional joining technologies may be used.

In step 310, attach resistor 122 to wire 127. In various embodiments, welding may be used to attach wire 127 to resistor 122 or another joining technology, for example, wire bonding, may be used.

In step 312, attach wire 127 to anode lead 139. In various embodiments, the attachment of wire 127 to anode lead 139 is done by welding, although other joining technologies, such as wire bonding, solder, or conductive adhesives may be used. In some embodiments, resistor 122 may be welded or directly attached to anode lead 139.

In step 314, overmold protective coat 140 is applied to capacitor core 130, resistor 122, diode 120, and associated connections and attachments. In an embodiment, overmold protective coat 140 is applied to the assembled capacitor core 130, diode 120, resistor 122, cathode leads 138, anode lead 139 and attachment wires 126 and 127. Protective coat 140 is applied to the structure, including the assembled integrated capacitor and LED with a current limiting resistor, to protect the electrical connections including wires, leads, and bonds such as welds, conductive adhesives, soldering, or wire bonds from handling and environmental damage. Protective coat 140 overmold leaves the LED dome exposed so that the lighting of diode 120, or activation of the LED, can be seen by an observer when a capacitor is operating above the capacitor's specified voltage rating.

In step 316, trim and form cathode lead 138 and anode lead 139. Using standard processes for manufacturing surface mount capacitors, the capacitor with an integrated indicator may be cut from the leadframe used for handling in the manufacturing process. Cathode lead 138 and anode lead 139 are formed to finish the capacitor as needed for assembly processes e.g. SMT card assembly.

As is understood by one skilled in the art, the steps depicted in the exemplary embodiment are an example of one method to assemble a capacitor with an integrated indicator and the selection of attachment or joining technologies (welding, wire bonding, adhesives, etc) and the order of these steps may differ for various manufacturers.

While the exemplary embodiment of the present invention illustrated in FIGS. 1-3 is a tantalum capacitor, other embodiments of the present invention are intended for application across most other capacitor types including for example, ceramic capacitors such as multilayer ceramic capacitors (MLCC's), ceramic disk capacitors, aluminum electrolytic capacitors and other electrolytic capacitors including plastic and paper based capacitors. The structure and method proposed for creating a tantalum capacitor with an integrated indicator for over voltages may apply to many other capacitor types that use a different capacitor core technology. For example, a capacitor core for a multilayer ceramic capacitor may consist of a sheet of ceramic foil, screen printed with a metal paste. The sheets are stacked and baked with pressure, cut and sintered. The appropriate ends are dipped and plated creating metal terminals for SMT soldering to a card. An embodiment of the present invention may use the multilayer ceramic capacitor with metal terminals as the capacitor core 130. Wires 126 and 127 can be attached by soldering or welding to the metal terminals, for example, and the attachments to diode 120 and resistor 122 done in a similar manner as described above. Similarly, a paper or plastic electrolytic capacitor could be created with a negative lead such as a lug or tab welded to the cathode foil. A positive lead may be similarly attached to the anode foil according to standard manufacturing practices however, in an embodiment of the present invention, a wire or metal tape may be attached or welded to the respective negative and positive leads or lugs of the plastic layers and to diode 120 and resistor 122 according to the previously described methods such that the dome of the LED will extend outside of the finished capacitor. The paper or plastic layers with an insulating layer may be rolled up and finished according to standard practices with the LED dome extending beyond the top of the roll. A protective coat such as an epoxy glob top or clear protective coat may be applied to complete the paper or plastic electrolytic capacitor with integrated overvoltage indicator.

The resulting integrated capacitors may be packaged and distributed by the manufacturer in a standard format such as a single capacitor, or packaged in a tray, a reel or roll format for example.

References in the specification to “one embodiment”, “other embodiment”, “another embodiment”, “an embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to affect such feature, structure, or characteristic in connection with other embodiments whether or not explicitly described.

For purposes of the description hereinafter, the terms “upper”, “lower”, “right”, “left”, “vertical”, “horizontal”, “top”, “bottom”, and derivatives thereof shall relate to the disclosed structures and methods, as oriented in the drawing Figures. The terms “on”, “over”, “overlying”, “atop”, “positioned on”, or “positioned atop” mean that a first element, such as a first structure, is present on a second element, such as a second structure, wherein intervening elements, such as an interface structure may be present between the first element and the second element. The terms “direct contact”, “directly on”, or “directly over” mean that a first element, such as a first structure, and a second element, such as a second structure, are connected without any intermediary conducting, insulating or semiconductor layers at the interface of the two elements. The terms “connected” or “coupled” mean that one element is directly connected or coupled to another element, or intervening elements may be present. The terms “directly connected” or “directly coupled” mean that one element is connected or coupled to another element without any intermediary elements present.

Having described the embodiments for a capacitor with an integrated indicator of the capacitor operating over a specified voltage rating (which are intended to be illustrative and not limiting), it is noted that modifications and variations may be made by persons skilled in the art in light of the above teachings. It is, therefore, to be understood that changes may be made in the particular embodiments disclosed which are within the scope of the invention as outlined by the appended claims.

What is claimed is:

1. A capacitor comprising:
a light emitting device calibrated to illuminate in response to a level of electrical stimulation;
a resistor connected to the light emitting device, a resistance of the resistor determined, at least in part, by the calibration of the light emitting device;
a capacitor core with a specified voltage rating for operation with at least a first capacitor lead and a second capacitor lead wherein the first capacitor lead connects to the resistor and the second capacitor lead connects to the light emitting device; and
a protective coat covering each of the connections between the light emitting device, the resistor, and the capacitor core, the protective coat covering such that the light emitting device is visible.

2. The capacitor of claim 1, wherein the light emitting device is calibrated to illuminate at a threshold voltage, the threshold voltage determined based, at least in part, on the specified voltage rating for operation of the capacitor.

3. The capacitor of claim 1, wherein the resistor limits current flowing to the light emitting device.

4. The capacitor of claim 1, wherein the capacitor is at least one of: a tantalum capacitor, a ceramic capacitor, an electrolytic capacitor, a plastic film capacitor, a super capacitor, and a double layer capacitor.

5. The capacitor of claim 1, wherein each of the connections between the capacitor leads, the resistor and the light emitting device are attached by one or more of: a wire, a metal ribbon, a wirebonding method, a weld, a conductive adhesive, and a soldering method.

6. The capacitor of claim 1, wherein the protective coat is one of: an overmold, a glob top, an epoxy, or a transparent coat.

7. The capacitor of claim 1, wherein the resistance of the resistor is determined, at least in part, by the calibration of the light emitting device and includes a specified current of the light emitting device.

8. A method of assembling a capacitor with an integrated indicator of operation over a specified voltage rating for operation of the capacitor, the method comprising:
calibrating a light emitting device to illuminate in response to a level of electrical stimulation;
determining a resistance of a resistor, based, at least in part, on the calibration of the light emitting device;
connecting the light emitting device to the resistor such that an electrical current flows through the resistor and subsequently flows through the light emitting device;
connecting a capacitor core with a specified voltage rating for operation to the resistor with a first capacitor lead and to the light emitting device with a second capacitor lead; and
applying a protective coat to each of the connections between the light emitting device, the resistor, and the capacitor core wherein the light emitting device is visible.

9. The method of claim 8, wherein calibrating the light emitting device to illuminate at a level of electrical stimulation further comprises calibrating the level of electrical stimulation to a threshold voltage level, the threshold voltage level determined, based at least in part, on the specified voltage rating for operation of the capacitor.

10. The method of claim 8, wherein determining the resistance of the resistor based, at least in part, on the calibration of the light emitting device further comprises limiting a current to the light emitting device to a current, based, at least in part, on a specified current of the light emitting device.

11. The method of claim 8, wherein the capacitor core is one of: a tantalum capacitor, a ceramic capacitor, an electrolytic capacitor, a plastic film capacitor, a super capacitor, and a double layer capacitor.

12. The method of claim 8, wherein each of the connections between the first capacitor lead, the second capacitor lead, the resistor, and the light emitting device are attached by one or more of: a wire, a metal ribbon, a wirebonding method, a weld, a conductive adhesive, and a soldering method.

13. The method of claim 8, wherein applying the protective coat is applying one of: an overmold, a glob top, an epoxy, or a transparent coat.

14. The method of claim 8, wherein the light emitting device and the resistor are integrated into a single component.

15. An integrated circuit for a capacitor with an integrated indicator of capacitor operation over a specified voltage rating for operation of the capacitor, the integrated circuit comprising:
a capacitor core with a specified voltage rating for operation connected to a light emitting device and a resistor, and the light emitting device connected to the resistor such that an electrical current flows through the resistor and subsequently flows through the light emitting device;
the light emitting device calibrated to illuminate in response to a level of electrical stimulation; and
a resistance of the resistor determined based, at least in part, on the calibration of the light emitting device.

16. The integrated circuit of claim 15, wherein the light emitting device calibrated to illuminate in response to a level of electrical stimulation comprises calibrating the level of electrical stimulation to a threshold voltage level, the threshold voltage level determined based, at least in part, on the specified voltage rating for operation of the capacitor core.

17. The integrated circuit of claim 15, wherein the resistance of the resistor determined based, at least in part, on the calibration of the light emitting device further comprises limiting a current to the light emitting device to a current based, at least in part, on the specified current of the light emitting device.

18. The integrated circuit of claim 15, wherein the capacitor core is one of: a tantalum capacitor, a ceramic capacitor, an electrolytic capacitor, a plastic film capacitor, a super capacitor, and a double layer capacitor.

19. The integrated circuit of claim 15, further comprising the light emitting device and the resistor connected in series; and the light emitting device and the resistor are connected in parallel to the capacitor core.

20. The integrated circuit of claim 15, wherein the light emitting device and the resistor are integrated into a single component.
